(19) United States
(12) Patent Application Publication
(10) Pub. No.: US 2019/0366614 A1
(43) Pub. Date: Dec. 5, 2019

(54) FILTER PLATE FOR PLASTIC PROCESSING APPARATUS

(71) Applicant: SHANGHAI JIANHUI PLASTIC TECHNOLOGY CO., LTD., Shanghai City (CN)

(72) Inventor: QINGHUI YI, SHANGHAI CITY (CN)

(21) Appl. No.: 16/395,485

(22) Filed: Apr. 26, 2019

(30) Foreign Application Priority Data
May 29, 2018 (CN) 201820807161.5

(51) Int. Cl. B29C 48/69; B29B 13/10

(52) U.S. Cl. CPC B29C 48/69; B29B 2017/0224; B29B 13/10

(57) ABSTRACT

Disclosed is a filter plate for a plastic processing apparatus, including: V-shaped grooves equidistantly formed in a plane of a mesh plate of the filter plate, V-shaped convex structures between adjacent V-shaped grooves. Filter holes having a predetermined aperture are provided on the bottom of the V-shaped grooves, and the side surfaces of the V-shaped convex structures. The top ends of the V-shaped convex structures are not provided with holes, and the outermost outer side of the V-shaped convex structure is facing downward without being provided with holes. The present invention increases the filtering area by 3-4 times without changing the aperture of filter hole, effectively extends the change cycle of filter during plastic production, and reduces waste of raw materials and the frequency of replacing filter plate during production and the labor intensity of the operators, which is beneficial to production safety and improvement of economic efficiency.

### BACKGROUND

### 1. Technical Field

The present invention relates to a filter plate, in particular to a filter plate for plastic processing apparatus.

### 2. Description of Related Art

In the production of plastic products, material filtration is an indispensable process. The main purpose is to remove impurities from the product. The method is to install a filter device in front of the extruder, and fill the filter with different specifications during the production to meet the product quality standards. During the production process, when the impurities are accumulated to a certain amount, the filter needs to be replaced. At this time, the system needs to stop working for replacing the filter, and then the apparatus is restarted when the replacement is done. This process not only wastes time, increases the labor intensity of the operators, but also loses parts of raw materials, resulting in increased costs and material waste.

When working on how to extend the time of changing the filter, that is, to improve the efficiency of the filter, the prior art generally only thinks about the area of the filter, but the aperture of the filter restricts the entire size of filter. Therefore, how to provide a filter plate in plastic processing apparatus which can improve the efficiency of the filter and prolong the time of changing the filter without adjusting the aperture of the filter plate, has become an urgent technical problem to be solved in the field.

### SUMMARY

The technical problem to be solved by the present invention is how to improve the efficiency of the filter mesh in plastic processing apparatus and extend the time of changing filter without changing the aperture of the filter plate.

The present invention adopts the following technical solutions.

A filter plate, for plastic processing apparatus, comprises: V-shaped grooves formed equidistantly in a plane of a mesh plate of the filter plate, V-shaped convex structures formed between adjacent V-shaped grooves, and filter hole having a predetermined aperture are formed in bottoms of the V-shaped grooves and side surfaces of the V-shaped convex structures; wherein, the top ends of the V-shaped convex structures are not provided with any holes, and outer side of outermost one of the V-shaped convex structures is facing downward without being provided with any holes.

Further, the V-shaped grooves have a depth of ¾-½ of the thickness of the filter plate and an included angle of 30-60 degrees.

Further, a folded portion of the filter plate has an arc shape, an elliptical arc shape, or a linear shape.

Further, the mesh plate has a thickness of 40-50 mm, and the corresponding V-shaped grooves have a depth of 30-40 mm.

Further, two filter holes which are staggered in the longitudinal direction are provided on an oblique side of the V-shaped convex structure in a lateral direction.

Further, the filter plate is made of a metal material.

Further, the filter holes are parallel to each other and perpendicular to the plane of the mesh plate of the filter plate.

The beneficial effects of the present invention are as follows.

1) The filter area is increased by 3-4 times without changing the aperture of filter hole, which can effectively extend the change cycle of filter and reduce the waste of raw materials during the plastic production.

2) The distribution of the mesh holes on both sides of the V-shaped groove is intended to reduce the impact strength of the melt on the mesh, and at the same time, the aperture area is the largest when the mesh hole is on an inclined plane. The purpose of providing holes at the bottom of the V-shaped grooves is to have a melt flowing at the bottom, which can flush the impurities on both sides of the V-shape grooves to the bottom, improve the filtration efficiency and prolong the time of changing the filter.

3) The outermost outer side of the folded portion of the filter plate is facing downward without being provided with any holes, and the purpose of which is to cause a dead angle to the flowing melt to avoid impurities passing therethrough or remaining therein.

4) The frequency of replacing filter plates and the labor intensity of operators are reduced, which is beneficial to the production safety and improvement of economic efficiency.

5) The impact direction of the melt on the mesh is improved to avoid breaking the filter when the melt pressure is excessively high.

6) The change cycle of filter can be extended by 4-6 times on the original basis, the product yield and production efficiency are increased, the production cost is reduced, and the economic benefits are thus significantly promoted.

### BRIEF DESCRIPTION OF THE DRAWINGS

FIG. 1 is a perspective view of the filter plate in plastic processing apparatus of the present invention.

FIG. 2 is a top plan view of the filter plate in plastic processing apparatus of the present invention.

FIG. 3 is a cross-sectional view taken along the line A-A of the filter plate in plastic processing apparatus of the present invention.

### DESCRIPTION OF THE EXEMPLARY EMBODIMENTS

The present invention is further described below in conjunction with the drawings and specific embodiments.

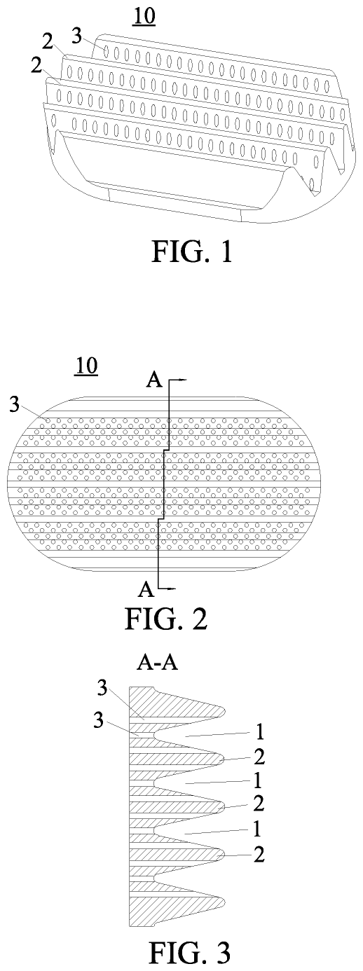

Referring to FIG. 1 to FIG. 3, a filter plate 10 in plastic processing apparatus includes V-shaped grooves 1 formed equidistantly in a plane of a mesh plate of the filter plate 10, V-shaped convex structures 2 between adjacent V-shaped grooves 1, filter holes 3 having a predetermined aperture provided on bottoms of the V-shaped grooves 1 and side surfaces of the V-shaped convex structures 2; wherein the top ends of the V-shaped convex structures 2 are not provided with any holes, and the outer side of the outermost one of the V-shaped convex structure 2 is facing downward without being provided with any holes. The mesh holes are distributed on both sides of the V-shaped convex structures 2, and the purpose of which is to reduce the impact strength of the melt on the mesh. At the same time, the aperture area is the largest when the mesh hole is on an inclined plane. The purpose of providing holes at the bottom of the V-shaped groove 1 is to have a melt flowing at the bottom, which can flush the impurities on both sides of the V-shape grooves 1 to the bottoms, improve the filtration efficiency and prolong the time of changing the filter.

In this embodiment, the V-shaped grooves 1 have a depth of ¾-½ of the thickness of the filter plate 10 and an included angle of 30-60 degrees.

In this embodiment, a folded portion of the filter plate 10 has an arc shape, an elliptical arc shape, or a linear shape.

In this embodiment, the mesh plate has a thickness of 40-50 mm, and the corresponding V-shaped grooves 1 have a depth of 30-40 mm.

In this embodiment, referring to FIGS. 1-3, two filter holes 3 which are staggered in the longitudinal direction are provided on an oblique side of the V-shaped convex structure 2 in a lateral direction.

In this embodiment, the filter plate 10 is made of a metal material.

In this embodiment, the filter holes 3 are parallel to each other and perpendicular to the plane of the mesh plate of the filter plate 10.

The distribution of the mesh holes on both sides of the V-shaped groove 1 is intended to reduce the impact strength of the melt on the mesh, and at the same time, the aperture area is the largest when the mesh hole is on an inclined plane. The purpose of providing holes at the bottoms of the V-shaped grooves 1 is to have a melt flowing at the bottoms, which can flush the impurities on both sides of the V-shape grooves 1 to the bottoms, improve the filtration efficiency and prolong the time of changing the filter. The outer side of the outermost one of V-shaped convex structures 2 is facing downward without providing an opening, and the purpose of which is to cause a dead angle to the flowing melt to avoid impurities passing therethrough or remaining therein.

In the design of the filter plate 10, the design of the angle and the design of the hole position on an inclined plane of the filter plate 10 are also very important.

The change cycle of filter can be extended by 4-6 times on the original basis, the product yield and production efficiency are increased, the production cost is reduced, and the economic benefits are thus significantly promoted.

The key to the solution of the present invention is to increase the area of the filter mesh without increasing the aperture area of the filter plate. By virtue of the present invention, the traditional design of filter plate structure is changed, and the design provided by the present invention also improves the impact direction of the melt on the mesh and avoids breaking the filter when the melt pressure is excessively high. The filter plate of the present invention is to design the traditional plate-plane structure into a corrugated shape, which increases the filtering area by 3-4 times, effectively extends the change cycle of filter, changes the mesh angle, prevents the melt from breaking through the filter mesh, and reduces the waste of raw materials during the production and the labor intensity of the operators, so as to benefit to the production safety and improvement of economic efficiency.

The above-mentioned descriptions represent merely an exemplary embodiment of the present invention, without any intention to limit the scope of the present invention thereto. Various equivalent changes, alterations or modifications based on the claims of the present invention are all consequently viewed as being embraced by the scope of the present invention.

What is claimed is:

1. A filter plate (10) for plastic processing apparatus, comprising:
V-shaped grooves (1) formed equidistantly in a plane of a mesh plate of the filter plate (10);
V-shaped convex structures (2) formed between adjacent V-shaped grooves (1); and
filter holes (3) having a predetermined aperture are formed in bottoms of the V-shaped grooves (1) and side surfaces of the V-shaped convex structures (2),
wherein the top ends of the V-shaped convex structures (2) are not provided with any holes, and
wherein outer side of outermost one of the V-shaped convex structures (2) is facing downward without being provided with any holes.

2. The filter plate (10) for plastic processing apparatus according to claim 1, wherein the V-shaped grooves (1) have a depth of ¾-½ of the thickness of the filter plate (10) and an included angle of 30-60 degrees.

3. The filter plate (10) for plastic processing apparatus according to claim 1, wherein a folded portion of the filter plate (10) has an arc shape, an elliptical arc shape, or a linear shape.

4. The filter plate (10) for plastic processing apparatus according to claim 1, wherein the mesh plate has a thickness of 40-50 mm, and the corresponding V-shaped grooves (1) have a depth of 30-40 mm.

5. The filter plate (10) for plastic processing apparatus according to claim 1, wherein two filter holes (3) which are staggered in the longitudinal direction are provided on an oblique side of the V-shaped convex structure (2) in a lateral direction.

6. The filter plate (10) for plastic processing apparatus according to claim 1, wherein the filter plate (10) is made of a metal material.

7. The filter plate (10) for plastic processing apparatus according to claim 1, wherein the filter holes (3) are parallel to each other and perpendicular to the plane of the mesh plate of the filter plate (10).
